(19) United States
(12) Patent Application Publication
(10) Pub. No.: US 2009/0207049 A1
(43) Pub. Date: Aug. 20, 2009

(54) METHOD FOR SMART ANNOUNCING OF BUS STOP

(75) Inventor: Shiun-Chih Liao, Taichung City (TW)

Correspondence Address: NIKOLAI & MERSEREAU, P.A., 900 SECOND AVENUE SOUTH, SUITE 820, MINNEAPOLIS, MN, 55402, US

(73) Assignee: CHUNGHWA UNITED TELEVISION CO., LTD., Taichung City (TW)

(21) Appl. No.: 12/031,988

(22) Filed: Feb. 15, 2008

(51) Int. Cl. G08G 1/123

(52) U.S. Cl. 340/988

(57) ABSTRACT

A method for announcing bus stop includes using a navigation positioning device to receive a satellite signal, retrieve current vehicle geographic longitude and latitude coordinates from the received signal, compare a databank thereof with the current geographic longitude and latitude coordinates, and, if any special position value is found, compute a distance from the current position to a next target position based on the special position value and the current geographic longitude and latitude coordinates; and using a microprocessor to compute parameters for adjusting a remaining distance and the remaining distance based on data from the navigation positioning device, or, in the event of a traffic jam in a tunnel, adjust the remaining distance according to detected vehicle speed data from a sensor, and determine whether to drive an AV device according to the remaining distance and the distance to the next target position to timely announce next bus stop.

### FIELD OF THE INVENTION

The present invention relates to a method for announcing bus stop, and more particularly to a method for smart announcing of bus stop.

### BACKGROUND OF THE INVENTION

Various kinds of transport vehicles play a very important role in the metropolitan mass transportation. Due to the high density of population in the metropolitan areas, the mass transportation is important and required, and is also complicated to bring confusions to people living at the metropolitan areas. The government positively encourages people to utilize the mass transportation facilities, such as high speed rail trains, mass rapid transit (MRT) trains, general trains, airplanes, etc. City bus is one of many vehicles for mass transportation and has very close relation to people's daily life. In the early stages, most city buses have a female bus captain assigned thereto, and the female bus captain informs the passengers of the name of the next stop before the city bus arrives at the stop. However, with the coming of electronic era, an electronic signboard provided in the city bus has replaced the female bus captain to display the name of the next stop.

FIG. 1 is a block diagram of a conventional bus stop announcing system 1, which includes a global positioning device 11 for receiving a positioning signal transmitted from a satellite 14, retrieving current vehicle geographic longitude and latitude coordinates and current vehicle speed from the received positioning signal, analyzing the current vehicle speed based on a basic vehicle speed, and sending the analyzed speed data to a microprocessor 12. The microprocessor 12 computes a predicted distance using the received speed data, so that a broadcasting device 13 is driven according to the predicted distance and a distance to the next stop.

When using the conventional bus stop announcing system 1 to perform the announcement of the arrival at a bus stop, the global positioning device 11 receives a positioning signal transmitted from the satellite 14, retrieves data of current vehicle geographic longitude and latitude coordinates and current vehicle speed from the received positioning signal, computes a distance between the current position and the next stop based on the current vehicle geographic longitude and latitude coordinates and coordinates of the next stop, analyzes the current vehicle speed based on a basic vehicle speed, and sends the analyzed speed data and the computed distance data to the microprocessor 12. The microprocessor 12 computes the predicted distance using the received speed data, so that the bus stop announcing system 1 drives the broadcasting device 13 according to the predicted distance and the distance to the next stop to inform passengers of the arrival at the next stop. While the above-described conventional bus stop announcing system is convenient for use, it has the following disadvantages:
1. When the bus encounters with an unexpected condition, such as traffic jam, accident, fire, etc., in a tunnel, the bus stop announcing system 1 might drive the broadcasting device 13 to announce the arrival at the next stop before the bus really arriving the stop, and thereby brings confusions and inconveniences to passengers.
2. When the bus passes through a tunnel, the global positioning device 11 is not able to transmit and receive signal to and from the satellite 14, and therefore, could not retrieve the current vehicle geographic longitude and latitude coordinates and the current vehicle speed to result in incorrect announcement of arrival at a next stop by the bus stop announcing system 1.

Therefore, it is tried by the inventor to develop a method for smart announcing of bus stop through a smart bus stop announcing system for a mass transportation vehicle to timely announce the next stop for passengers to have sufficient time to get ready for getting off without the risk of rushing to or staying at the bus door.

### SUMMARY OF THE INVENTION

A primary object of the present invention is to provide a method for smart announcing of bus stop, which is implemented through a smart bus stop announcing system having a navigation positioning device, a sensor, a microprocessor, and an audio-visual (AV) device. The navigation positioning device receives a satellite signal from a satellite and retrieves current vehicle geographic longitude and latitude coordinates from the received satellite signal. The navigation positioning device compares a databank thereof with the current vehicle geographic longitude and latitude coordinates to determine whether there is a special posit ion value, such as a tunnel, and, if yes, computes a distance from the current position to a next target position, such as a stop, based on the special position value and the current vehicle geographic longitude and latitude coordinates. The microprocessor of the bus stop announcing system receives data from the navigation positioning device and computes parameters for adjusting a remaining distance and the remaining distance; or, in the event of a traffic jam in the tunnel, the sensor detects and sends vehicle speed data to the microprocessor, so that the microprocessor adjusts the remaining distance and the parameters for adjusting the remaining distance based on the detected speed data, and determines whether to drive the AV device according to the remaining distance and the distance to the next target position, so as to solve the problem of early announcement of the arrival at the next stop to ensure that passengers are timely informed of the arrival at the next stop.

Another object of the present invention is to provide a method for smart announcing of bus stop, which is implemented through a smart bus stop announcing system having a navigation positioning device, a sensor, a microprocessor, and an AV device. The navigation positioning device is internally provided with a databank and a basic vehicle speed data. When the navigation positioning device receives a satellite signal from a satellite, it retrieves current vehicle geographic longitude and latitude coordinates from the received satellite signal, computes to obtain the current vehicle speed data, and compares the databank with the current vehicle geographic longitude and latitude coordinates. When a special position value is located from the comparison, the navigation positioning device computes a distance from the current position to the next stop based on the coordinates of the special position value and the current vehicle geographic longitude and latitude coordinates, and analyzes the current vehicle speed based on the basic vehicle speed data. The analyzed speed data and distance data are sent to the microprocessor for the same to compute parameters for adjusting a remaining distance and the remaining distance based on the received speed data. In the event the vehicle encounters a traffic jam in a tunnel, the sensor detects and sends vehicle speed data to the microprocessor, so that the microprocessor adjusts thee remaining distance and the parameters for adjusting the remaining distance based on the detected speed data, and determines whether to drive the AV device according to the remaining distance and the distance to the next target position, so that passengers are timely informed of the arrival at the next stop and have sufficient time to get ready for getting off the vehicle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional bus stop announcing system;

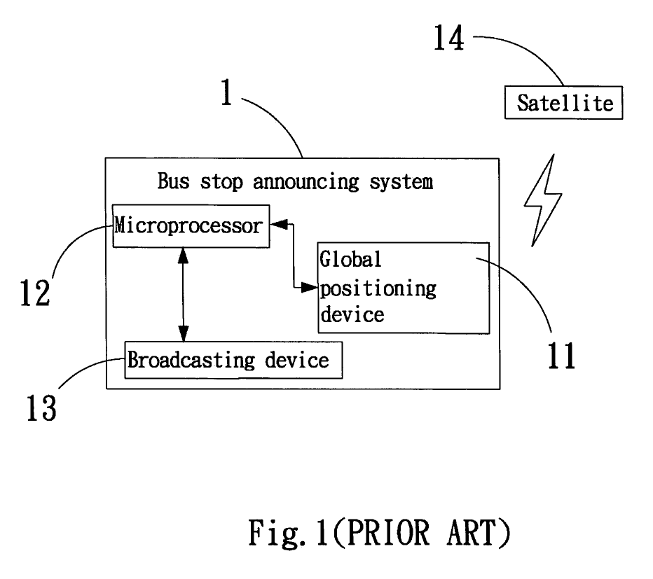

FIG. 2 is a block diagram of a smart bus stop announcing system for implementing a method for smart announcing of bus stop according to the present invention; and

FIG. 3 is a flowchart showing the steps included in the method for smart announcing of bus stop according to the present invention.

### DETAILED DESCRIPTION OF THE PREFERRED EMBODIMENTS

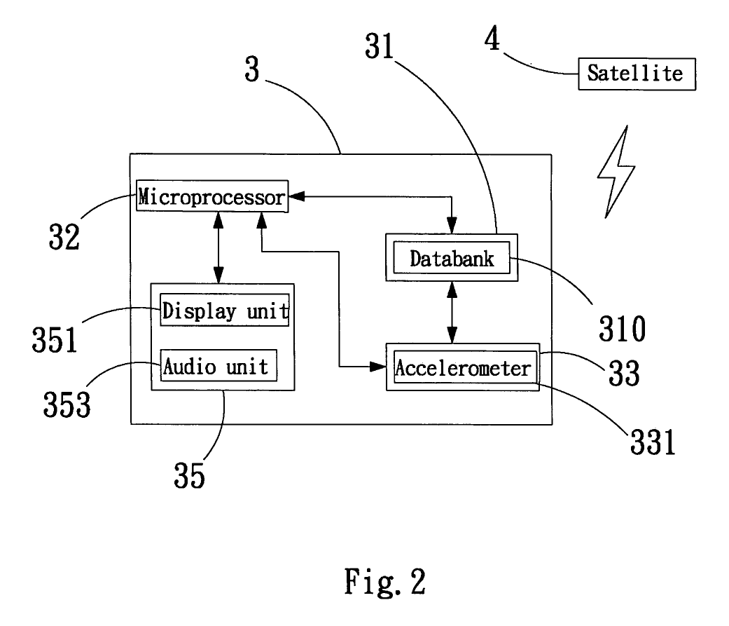

Please refer to FIG. 2 that is a block diagram of a smart bus stop announcing system 3 used to implement a method for smart announcing of bus stop according to the present invention. The present invention is applicable to a transport vehicle, such as a city bus. The smart bus stop announcing system 3 includes at least a navigation positioning device 31, a microprocessor 32, a senior 33, and an audio-visual (AV) device 35. In a preferred embodiment of the present invention, the navigation positioning device 31 is provided with a databank 310 and a basic vehicle speed data. In the basic vehicle speed data, there is a preset vehicle speed per hour, such as, for example, 40 km. In the databank 310, there is a scheduled route data, such as electronic map information, and the scheduled route data includes at least one special position value and at least one target position. The special position value may be a tunnel position, and the target position maybe a bus station, a bus stop, etc. The navigation positioning device 31 is electrically connected to the microprocessor 32, and the microprocessor 32 is electrically connected to the AV device 35. The AV device 35 includes a display unit 351 and an audio unit 353. The display unit 351 may be a liquid crystal display (LCD) for displaying text messages. The audio unit 353 may be a loudspeaker for sending out an audio message as an announcement.

The sensor 33 includes an accelerometer 331 for measuring the speed of a transportation vehicle. The accelerometer 331 is electrically connected to the navigation positioning device 31 and the microprocessor 32, and utilizes an inertial navigation system (INS) as a measuring way to detect the speed of a transportation vehicle. Since the measuring way based on the inertial navigation system belongs to a highly specialized technical field, and is not a subject matter of the present invention, it is not discussed in details herein.

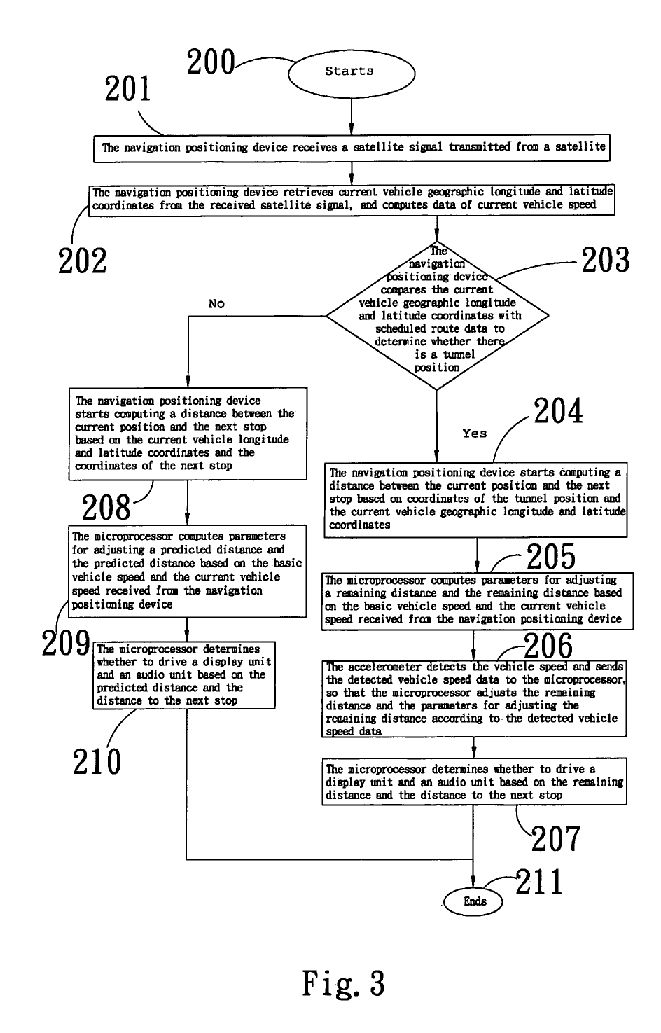

Please refer to FIG. 3. In a preferred embodiment of the present invention, the navigation positioning device 31 may transmit and receive signals to and from a satellite 4. When the bus is approaching to a tunnel or encounters an unexpected condition in a tunnel, such as a traffic jam or an accident, the smart bus stop announcing system 3 will operate in the following steps:

(200) Starts operating;

(201) The navigation positioning device 31 receives a satellite signal from the satellite 4;

(202) The navigation positioning device 31 retrieves data of current vehicle geographic longitude and latitude coordinates based on the received satellite signal, and computes to obtain data of current vehicle speed;

(203) The navigation positioning device 31 compares the data of current vehicle geographic longitude and latitude coordinates with the scheduled route data to determine whether there is a tunnel position; if yes, the navigation positioning device 31 would perform the following step (204); and if not, the navigation positioning device 31 would perform the following step (208);

(204) The navigation positioning device 31 computes a distance between the current position and the next stop based on the coordinates of the tunnel position and the data of current vehicle longitude and latitude coordinates;

(205) The microprocessor 32 computes parameters for adjusting a remaining distance and the remaining distance based on the basic vehicle speed data and the data of current vehicle speed received from the navigation positioning device 31;

(206) The accelerometer 331 detects the vehicle speed and sends the detected vehicle speed data to the microprocessor 32, so that the microprocessor 32 adjusts the remaining distance and the parameters for adjusting the remaining distance according to the detected vehicle speed data;

(207) The system 3 determines whether to drive the display unit 351 and the audio unit 353 based on the remaining distance and the distance to the next stop; or

(208) The navigation positioning device 31 starts computing a distance between the current position and the next stop based on the current vehicle longitude and latitude coordinates and the coordinates of the next stop;

(209) The microprocessor 32 computes the parameters for adjusting a predicted distance and the predicted distance based on the basic vehicle speed data and the current vehicle speed data received from the navigation positioning device 31;

(210) The system 3 determines whether to drive the display unit 351 and the audio unit 353 based on the predicted distance and the distance to the next stop; and

(211) Ends one cycle of operation.

Please refer to FIGS. 2 and 3. In the preferred embodiment of the present invention, before the bus entering into a tunnel, the satellite 4 and the navigation positioning device 31 communicate with each other. When the satellite 4 transmits a satellite signal to the navigation positioning device 31, the latter analyzes and retrieves from the received satellite signal the current vehicle geographic longitude and latitude coordinates, and computes the current vehicle speed, so that the navigation positioning device 31 may compare the current vehicle geographic longitude and latitude coordinates with the scheduled route data to determine whether there is any tunnel position. If it is determined there is a tunnel position, the navigation positioning device 31 starts computing the distance from the current position to the next stop based on the coordinates of the tunnel position and the current vehicle geographic longitude and latitude coordinates. When the distance to the next stop is obtained, the navigation positioning device 31 analyzes the current vehicle speed data based on the basic vehicle speed data. Thee analyzed vehicle speed data and the distance data are simultaneously sent to the microprocessor 32. The microprocessor 32 computes the parameters for adjusting the remaining distance and the remaining distance based on the received vehicle speed data. In the event the bus is jammed in the tunnel, the accelerometer 331 starts detecting the bus speed and sends the detected speed data to the microprocessor 32, so that the microprocessor 32 adjusts the remaining distance and the parameters for the remaining distance according to the detected bus speed data, and determines whether to drive the display unit 351 and the audio unit 353 according to the remaining distance and the distance to the next stop. Therefore, the problem of early announcement of arrival at the next stop caused by a traffic jam in the tunnel may be solved and passengers on the bus may be correctly informed of the arrival at the next stop.

On the other hand, if it is determined no tunnel is found from the comparison of the current vehicle geographic longitude and latitude coordinates with the scheduled route data, the navigation positioning device 31 starts computing the distance from the current position to the next stop based on the current vehicle geographic longitude and latitude coordinates and the coordinates of the next stop. When the distance to the next stop is obtained, the navigation positioning device 31 analyzes the current vehicle speed data based on the basic vehicle speed data. The analyzed vehicle speed data and the computed distance data are simultaneously sent to the microprocessor 32. The microprocessor 32 computes the parameters for adjusting the predicted distance and the predicted distance based on the received vehicle speed data, and determines whether to drive the display unit 351 and the audio unit 353 according to the predicted distance and the distance to the next stop, so that passengers on the bus may be timely informed of the arrival at the next stop and get ready for getting off the bus.

In computing the parameters for adjusting the remaining distance or the predicted distance, as well as the remaining distance or the predicted distance, the microprocessor 32 may utilize an artificial neural system or a fuzzy system to control the computing, so that the computing of most appropriate bus stop announcing time can be achieved. Since the computing based on an artificial neural system or a fuzzy system belongs to a highly specialized technical field, and is not a subject matter of the present invention, it is not discussed in details herein.

In conclusion, the present invention advantageously provides a method for smart announcing of bus stop that enables passengers on a mass transportation vehicle to timely know the arrival at the next stop and have sufficient time to get ready for getting off without the need of rushing to or staying at the bus door. Therefore, the vehicle provides the passengers with more conveniences in taking the vehicle. Moreover, with the method of the present invention, the arrival at the next stop is automatically announced via the bus stop announcing system, it is not necessary for the vehicle driver to personally operate the bus stop announcing system or pay attention to the timing announcement of arrival at the next stop during driving. Therefore, the driver is allowed to concentrate in driving to ensure the safety of passengers.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method for smart announcing of bus stop applicable to a transportation vehicle, the method being implemented through a smart bus stop announcing system having a navigation positioning device, a sensor, a microprocessor, and an audio-visual (AV) device, and comprising the following steps:
the navigation positioning device receiving a satellite signal transmitted by a satellite;
the navigation positioning device retrieving current vehicle geographic longitude and latitude coordinates from the received satellite signal, and computing to obtain data of current vehicle speed;
the navigation positioning device comparing a databank built therein with the current vehicle geographic longitude and latitude coordinates, and determining whether there is a special position value as set in a scheduled route data in the databank;
the navigation positioning device starting computing a distance from the current position to a next target position in the scheduled route data, based on coordinates of the special position value and the current vehicle geographic longitude and latitude coordinates;
the microprocessor computing parameters for adjusting a remaining distance and a remaining distance, based on basic vehicle speed data set in the navigation positioning device and the data of current vehicle speed;
the sensor detecting a speed of the transportation vehicle and sending the detected speed data to the microprocessor, so that the microprocessor adjusts the remaining distance and the parameters for the remaining distance based on the, detected speed data; and
the microprocessor determining whether to drive the AV device based on the remaining distance and the distance to the next target position to timely inform passengers of the arrival at the next stop.

2. The method for smart announcing of bus stop as claimed in claim 1, wherein the sensor is an accelerometer.

3. The method for smart announcing of bus stop as claimed in claim 2, wherein the accelerometer may utilize an inertial navigation system as a measuring way to detect the speed of the transportation vehicle.

4. The method for smart announcing of bus stop as claimed in claim 1, wherein, in computing the parameters for adjusting the remaining distance and the remaining distance, the microprocessing may utilize an artificial neural system or a fuzzy system to control the computing, so that the computing of most appropriate bus stop announcing time can be achieved.

5. The method for smart announcing of bus stop as claimed in claim 1, wherein the AV device includes a display unit.

6. The method for smart announcing of bus stop as claimed in claim 1, wherein the AV device includes an audio unit.

7. The method for smart announcing of bus stop as claimed in claim 5, wherein the display unit is an LCD.

8. The method for smart announcing of bus stop as claimed in claim 6, wherein the audio unit is a loudspeaker.
